(19) United States
(12) Patent Application Publication
(10) Pub. No.: US 2009/0029733 A1
(43) Pub. Date: Jan. 29, 2009

(54) METHOD AND APPARATUS FOR CONTROLLABLE FILTERING ON MULTIPLEXED DATA BUS PORTS

(75) Inventors: GREGORY L. SCHILLING, LAKE IN THE HILLS, IL (US); ALDEN R. ALVIAR, INDIAN CREEK, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/829,465

(22) Filed: Jul. 27, 2007

(51) Int. Cl. H04B 1/38

(52) U.S. Cl. 455/557

(57) ABSTRACT

A communication device (203) can include a external data port (110) for at least data transfer and audio transmission and a switchable radio frequency protection circuit (205, 300, 400 or 500) that switches in a resonant circuit or filter circuit (312, 322, 412, 422, 512, or 522) upon detection of an audio transmission and switches out the resonant circuit or filter circuit upon detection of data transfer over the external data port. The switchable protection circuit include a computer processing unit controlled switching device (316) or a hardware identifier controlled switching device (314) or both. The communication device can further include data plus (+) and data minus (−) lines for audio receive and audio transmit. The communication device can also be a laptop for example. The external data port can be a multiplexed port supporting at least data transfer and audio and optionally battery charging.

### FIELD

This invention relates generally to filtering on multiplexed data bus ports, and more particularly to a method and system of filtering on multiplex data ports suitable for audio and data transmission.

### BACKGROUND

Communication devices such as GSM cellular phones usually have an external port for the plugging-in of wired accessories. This port is usually multiplexed to enable several functions such as charging batteries for the phone, data transfer (USB 2.0) for synchronization or updating of email or calendaring information and audio (using mono or stereo headset for example). In the communication device, the proximity of the radio frequency (RF) antenna and circuitry can make an audio device plugged into the communication device susceptible to RF energy.

For a GSM phone which has an audio port that is particularly sensitive to its own RF transmitter bursts, the audio interference frequency coupled RF energy is approximately 217 Hz, which is audible and well within the audio range of the typical user. When an audio headset is connected, it uses the D+/D− lines as audio receive and transmit lines. If RF energy gets coupled onto the receive line, the user will experience an audible buzz in the earpiece of the audio headset. If the RF energy gets coupled onto the transmit line, the person the user is talking with will experience an audible buzz in their earpiece as a result on the energy being coupled into the microphone of the device.

One patent publication, U.S. Patent Publication No: US2006/0223570 A1, describes how to protect audio transducers from electromagnetic interference (EMI), but only suggests protecting high speed data lines with only a serial common mode choke or protecting near the transducer on the accessory itself. Such solutions fail to enable solutions that allow the desired protection regardless of the accessory being attached to the communication device.

### SUMMARY

Embodiments in accordance with the present invention can provide a method and device that enables a designer an option to protect against such buzz on data lines (D+/D−) to better improve audio performance of a device while not diminishing or hampering data transfer performance. This circuit or scheme can be used on any multiplexed port that supports data transfer and other features. Examples would include laptop external ports, Mini-USB and Micro-USB.

In a first embodiment of the present invention, a communication device can include an external data port for at least data transfer and audio transmission and a switchable radio frequency protection circuit that switches in a resonant circuit or filter circuit upon detection of an audio transmission and switches out the resonant circuit or filter circuit upon detection of data transfer over the external data port. The switchable protection circuit includes a computer processing unit controlled switching device or a hardware identifier controlled switching device or both. The communication device can further include data plus (+) and data minus (−) lines for audio receive and audio transmit. In one example, the communication device can be a cellular phone having a high speed USB data port used for both data transfer and audio transmission where the switchable radio frequency protection circuit selectively eliminates radio frequency coupling. In another example, the communication device can be a GSM cellular phone where the external data port includes a USB connector having a data + line and a data − line used for both data transfer and audio transmission. The communication device can also be a laptop for example. The external data port can be a multiplexed port supporting at least data transfer and audio.

In a second embodiment of the present invention, a circuit for eliminating radio frequency coupling to a multiplexed high speed port supporting data transfer and audio transmission can include a pair of data lines used for audio receive and audio transmit via the multiplexed high speed port and a switchable radio frequency protection circuit that switches in a resonant circuit or a filter circuit upon detection of an audio transmission and switches out the resonant circuit or filter circuit upon detection of a data transfer over the external data port. The switchable protection circuit can include a computer processing unit (CPU) controlled switching device or a hardware identifier controlled switching device. The circuit can be a portion of a cellular phone having a high speed USB data port used for both data transfer and audio transmission where the switchable radio frequency protection circuit selectively eliminates radio frequency coupling during audio transmission. The circuit can also be a portion of a GSM cellular phone where the multiplexed high speed port includes a USB connector having a data + line and a data − line used for both data transfer and audio transmission. The multiplexed high speed port can be a multiplexed port supporting at least data transfer, audio transmission, and battery charging.

In a third embodiment of the present invention, a method of eliminating radio frequency coupling to a multiplexed high speed port supporting data transfer and audio transmission can include the steps of selectively using the multiplexed high speed data port over a pair of data lines for audio receive and audio transmit or for data transfer, switching in a switchable radio frequency protection circuit (such as a resonant circuit or a filter circuit) upon detection of an audio transmission on the multiplexed high speed data port, and switching out the switchable radio frequency protection circuit upon detection of a data transfer over the multiplexed high speed data port. The method can further include the step of controlling the switchable radio frequency protection circuit using a computer processing unit controlled switching device or a hardware identifier controlled switching device or both. The method can selectively eliminate radio frequency coupling during audio transmission by switching in the switchable radio frequency protection circuit. Note, the method can also selectively support battery charging via the multiplexed high speed port.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. An “external data port” in the context herein can mean any external port that provides access in a multiplexed fashion to an audio portion and a high speed data portion of an electronic device such as a cellular phone or a computing device. A “switchable radio frequency (RF) protection circuit” can mean any switching device selectively controls resonant or filter circuits under conditions that might cause RF coupling as further describe herein.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an existing communication device having a limited radio frequency protection circuit.

FIG. 2 is a communication device having a switchable radio frequency protection circuit in accordance with an embodiment of the present invention.

FIG. 3 is a block diagram of a switchable radio frequency protection circuit in accordance with an embodiment of the present invention.

FIG. 4 is a block diagram of another switchable radio frequency protection circuit in accordance with an embodiment of the present invention.

FIG. 5 is a block diagram of yet another switchable radio frequency protection circuit in accordance with an embodiment of the present invention.

FIG. 6 is a block diagram of an electronic device in accordance with an embodiment of the present invention.

FIG. 7 is flow chart illustrating a method of eliminating radio frequency coupling to a multiplexed high speed port in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of ways using a number of switching schemes and circuit arrangements where a resonant circuit or filter circuit is shunted to ground to selectively protect a multiplexed high speed port.

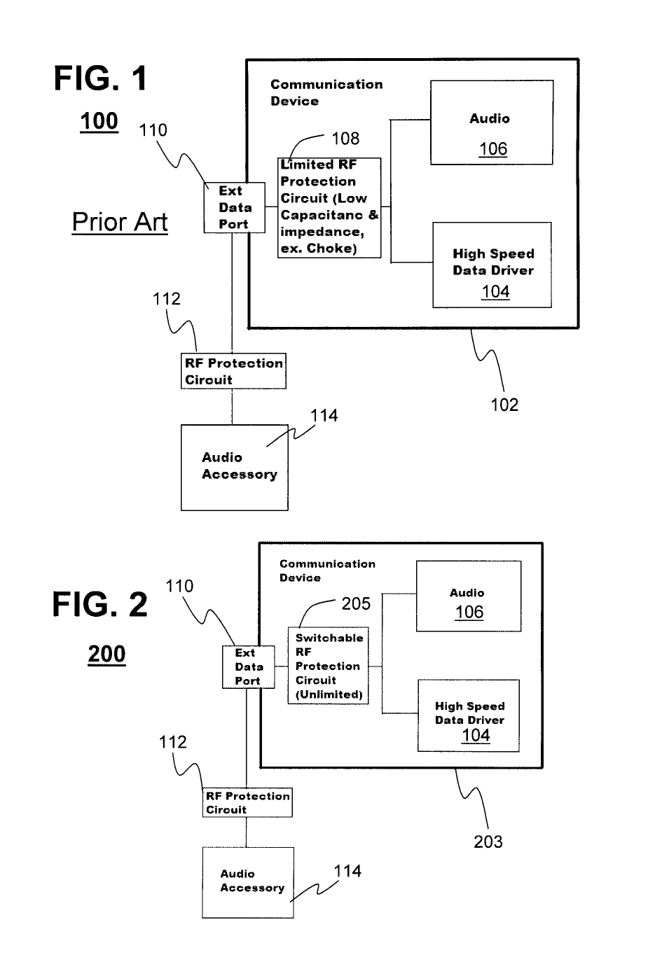

If a skilled designer of cellular phone devices attempts to merely use a resonant circuit tuned to the interfering RF frequency parallel to the audio to the audio line to shunt the RF energy to ground, such arrangement will still fail to adequately enable the appropriate performance for both audio and data transmission on a multiplexed data line since such arrangement will excessively load down the data transfer aspects. A current arrangement as shown in FIG. 1 illustrates a communication system 100 having a communication device 102 having a external data port 110 that is multiplexed to an audio circuit 106 and a high speed data driver 104. An audio accessory 114 that couples to the communication device 102 might have it's own RF protection circuitry. In any event, the communication device 102 includes a limited RF protection circuit that has low capacitance and low impedance such as a common mode choke. This resonant circuit is placed near the vicinity of the external port 110 and provides RF protection limited to the low capacitance and low loading requirements of the data line of the external port.

The external port that multiplexes data transfer and audio will not operate appropriately (particularly for data transfer) when the port is loaded down too much. For example, with respect to the data transfer feature in a USB 2.0 device scenario, the USB 2.0 specification states that no more than 1 pF loading on the D+/D− lines is acceptable. This restriction prohibits the opportunity to add any resonant circuitry to the communication device and therefore leaves the D+/D− susceptible to the RF energy on the communication device. Further implications of higher speed data transfer will only make it more difficult to shunt this energy with requirements to decrease the amount of loading on these lines even more.

When using a power supply to drive audio on a GSM cellular phone, protection for the audio lines from outside interferences & RF energy generated by the main antenna is generally needed. Currently, in most GSM cellular phone designs, the high speed data lines are also used as audio lines when connected to an audio accessory. These lines are usually left unfiltered or minimum filtering is provided to protect these lines due to the requirements for high speed data transfer. On some GSM cellular phones, the high speed data port is near the main antenna of the phone. With these lines unfiltered, the antenna energy can get picked up when a audio accessory is connected and the user starts experiencing a buzzing sound either in the earpiece from the receive side or the person on the other end of the communication line will hear a buzz that gets generated in the transmit side. The requirements for high speed data transfer limit the amount of loading that can be done on these lines. Again, an example of the existing conflict between providing adequate RF protection and limiting the loading on data lines is found in the specification for USB that states that the USB lines can not be loaded down with much capacitance (1.0 pF max to ground on D+/D− and 5.0 pF max differential across differential pair D+/D−) to work properly for USB 2.0.

Embodiments as illustrated in FIGS. 2 through FIG. 5 can allow circuit designers to utilize the ability to add resonant & filter circuits using a controlled switch when the data (D+/D−) lines are used as audio lines to help protect them from GSM audio buzz or other interference. The circuit can include a switch controlled either by a CPU or by Hardware ID on the wired audio accessory via a logic circuit that will switch on and off depending if it is connected. More specifically, Referring to FIG. 2, a communication system 200 having a communication device 203 can include a external data port 110 for at least data transfer via a high speed data driver 104 and audio transmission to and from audio circuitry 106. The communication system 200 can be similar to communication system 100 and can include the audio accessory 114 and RF protection circuit 112 as previously described. The communication device 203 can further include a switchable radio frequency protection circuit 205 that switches in a resonant circuit or filter circuit upon detection of an audio transmission and switches out the resonant circuit or filter circuit upon detection of data transfer over the external data port. Note, TV and/or video output can also be multiplexed on the external data port 110 and classified similarly to an audio transmission since much of current TV output is analog in nature. However, future video output implementations from a mobile handset can fall under “high speed data transfer” when the video output becomes digital. Thus, the high speed data driver 104 can also include video data transfer within contemplation of the embodiments herein.

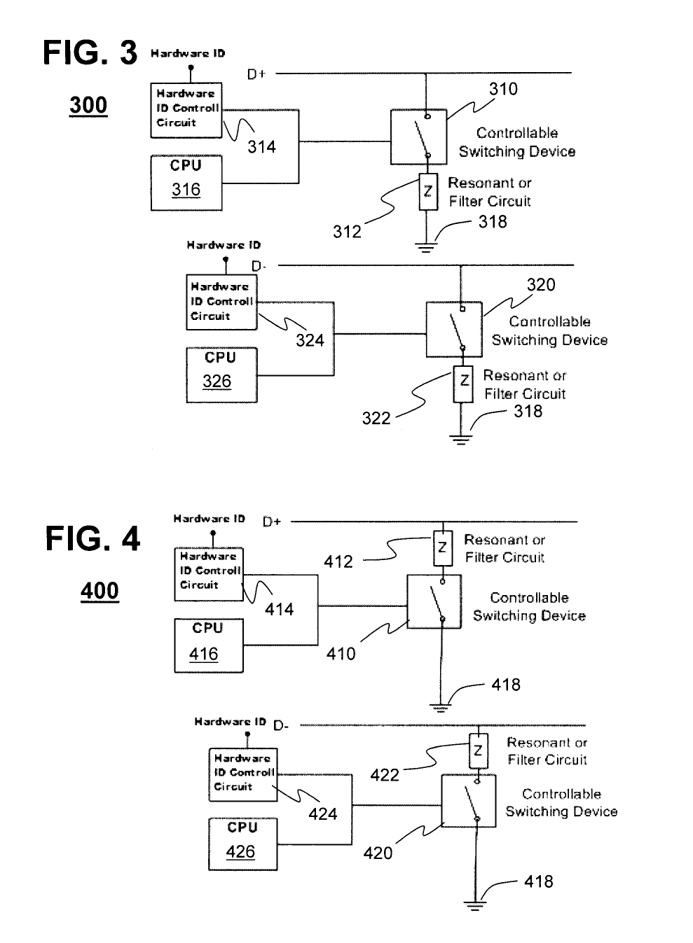

Referring to FIGS. 3-5, several alternative embodiments are shown for the swtichable radio frequency protection circuit. If the audio device is connected from the high speed data port, the D+/D− lines will connect to the proper filtering it needs to protect it from GSM buzz or other interference. If the audio device is disconnected from the high speed data port, the filtering is disconnected from both D+/D− and will thus meet the recommended requirements for filtering for high speed data transfer.

Referring to FIG. 3, a swtichable RF protection circuit 300 can include either a CPU 316 for controlling a controllable switching device 310 or a hardware ID control circuit 314 for controlling the controllable switching device 310 or both. The swtichable RF protection circuit 300 can also include either a CPU 326 for controlling a controllable switching device 320 or a hardware ID control circuit 324 for controlling the controllable switching device 320 or both. The switchable radio frequency protection circuit 300 switches in a resonant circuit or filter circuit 312 or 322 upon detection of an audio transmission and switches out the resonant circuit or filter circuit upon detection of data transfer over the external data port. The circuits 312 and 322 are both connected to ground 318. Note in this embodiment that the circuit 300 is either CPU controlled or hardware ID controlled and that each switch is controlled individually. Further note that the resonant or filter circuit in this embodiment is connected to the ground side of the controllable switch.

Referring to FIG. 4, a swtichable RF protection circuit 400 can include either a CPU 416 for controlling a controllable switching device 410 or a hardware ID control circuit 414 for controlling the controllable switching device 410 or both. The swtichable RF protection circuit 400 can also include either a CPU 426 for controlling a controllable switching device 420 or a hardware ID control circuit 424 for controlling the controllable switching device 420 or both. The switchable radio frequency protection circuit 400 switches in a resonant circuit or filter circuit 412 or 422 upon detection of an audio transmission and switches out the resonant circuit or filter circuit upon detection of data transfer over the external data port. Note in this embodiment that the circuit 400 is either CPU controlled or hardware ID controlled and that each switch is controlled individually. Further note that the resonant or filter circuit in this embodiment is connected to the data line side of the controllable switch. In other words, circuits 412 and 422 are both permanently connected to the data line side of the switch and are both selectively connected to ground 418 via the controllable switching device 410 or 420.

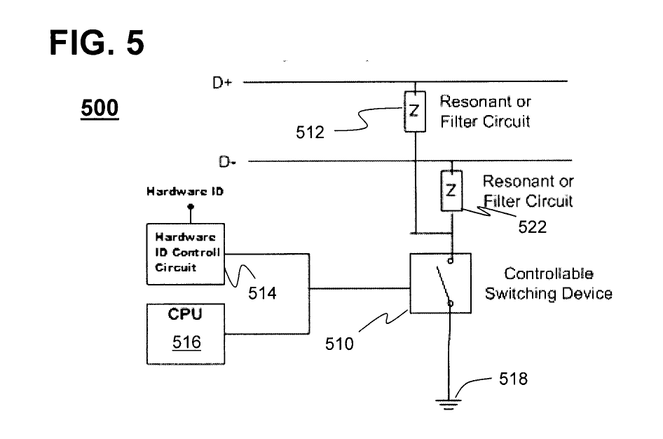

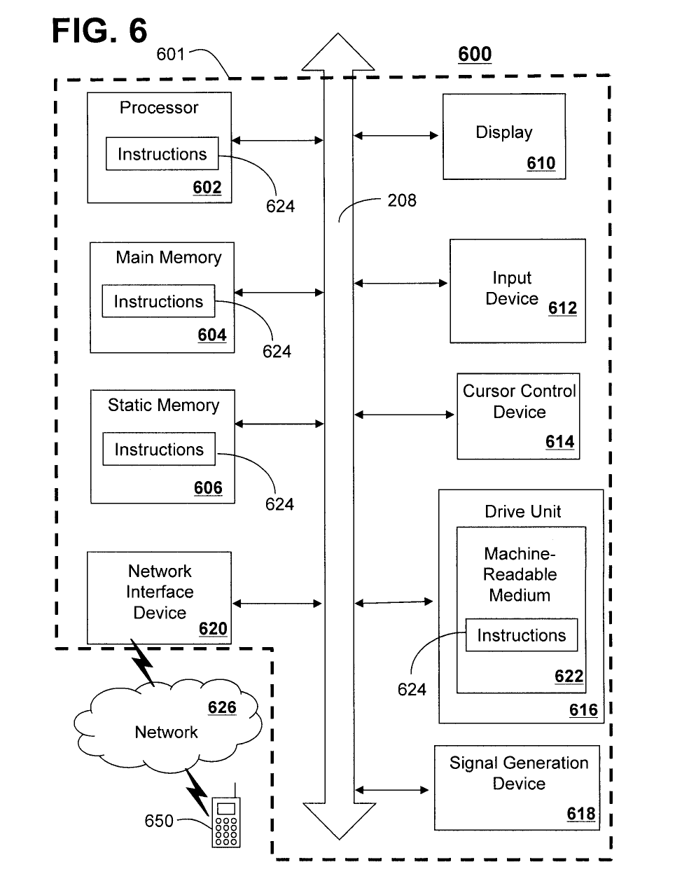

Referring to FIG. 5, another swtichable RF protection circuit 500 can include either a CPU 516 for controlling a controllable switching device 510 or a hardware ID control circuit 514 for controlling the controllable switching device 510 or both. The switchable radio frequency protection circuit 500 switches in a resonant circuit or filter circuit 512 or 522 upon detection of an audio transmission and switches out the resonant circuit or filter circuit upon detection of data transfer over the external data port (on the data lines). The circuits 512 and 522 are both connected to the data line side of the controllable switching device 510. Note again that in this embodiment that the circuit 500 is either CPU controlled or hardware ID controlled and that each switch is controlled individually. Circuits 512 and 522 are both permanently connected to the data line side of the switch and are both selectively connected to ground 518 via the controllable switching device 510.

Currently, due to high speed data requirements, the data lines are required to be minimally filtered (choke or low capacitance protection). With the embodiments herein, a designer will now have the ability to protect the lines within the communication device itself when used for audio purposes rather than relying on the protection provided by an audio accessory. This arrangement will give designers the option to add any resonant & filter circuits anywhere from the audio source (power supply, audio amplifier, etc.) to near the connector of an external port with the electronic communication device to mask off potential RF energy when they are used for audio without sacrificing the data transfer performance. The designer will have the option of turning on a controllable switch which can connect the data lines to either a resonant or filter circuit when the audio accessory is connected to that port. Likewise, the switch can disconnect from the resonant or filter circuit and meet the requirement for minimum loading on the lines to work optimal for high speed data transfer.

The embodiments described can resolve the problems currently presented on GSM cellular devices by selectively adding resonant & filter circuits to the high speed data lines to mask off any GSM buzz being coupled either into the receive side (audible in the earpiece on the user's wired headset) or the transmit side (into the microphone of the wired headset and audible to the person the communication device is connected to or on a phone call with). Most cellular phones on the market use this high speed data port configuration for charging, data transfer & wired audio accessories. Such arrangement will reduce or eliminate GSM buzz or similar interference on data lines (D+/D−) to better improve their audio performance. This circuit can also be used on any multiplexed port that supports data transfer and other features. Examples would include laptop external ports, Mini-USB and Micro-USB.

In another embodiment of the present invention as illustrated in the diagrammatic representation of FIG. 6, an electronic product 600 such as a machine having such a switchable RF protection circuit (205, 300, 400, or 550) can include a processor or controller 602 coupled or forming a portion of the protection circuit. Generally, in various embodiments, the product can be thought of as a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 601 and a sending device 650 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication or presentations. Further, while a single machine is illustrated, the term “machine” shall also be taken to include any collection of machines that individually or jointly execute a set (or multiple sets) of instructions to perform any one or more of the methodologies discussed herein.

The computer system 600 can include a controller or processor 602 (e.g., a central processing unit (CPU), a graphics processing unit (GPU, or both), a main memory 604 and a static memory 606, which communicate with each other via a bus 608. The computer system 600 may further include a presentation device such a display 610. The computer system 600 may include an input device 612 (e.g., a keyboard, microphone, etc.), a cursor control device 614 (e.g., a mouse), a disk drive unit 616, a signal generation device 618 (e.g., a speaker or remote control that can also serve as a presentation device) and a network interface device 620. Of course, in the embodiments disclosed, many of these items are optional.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor or controller 602 during execution thereof by the computer system 600. The main memory 604 and the processor or controller 202 also may constitute machine-readable media.

Dedicated hardware implementations including, but not limited to, application specific integrated circuits, programmable logic arrays, FPGAs and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

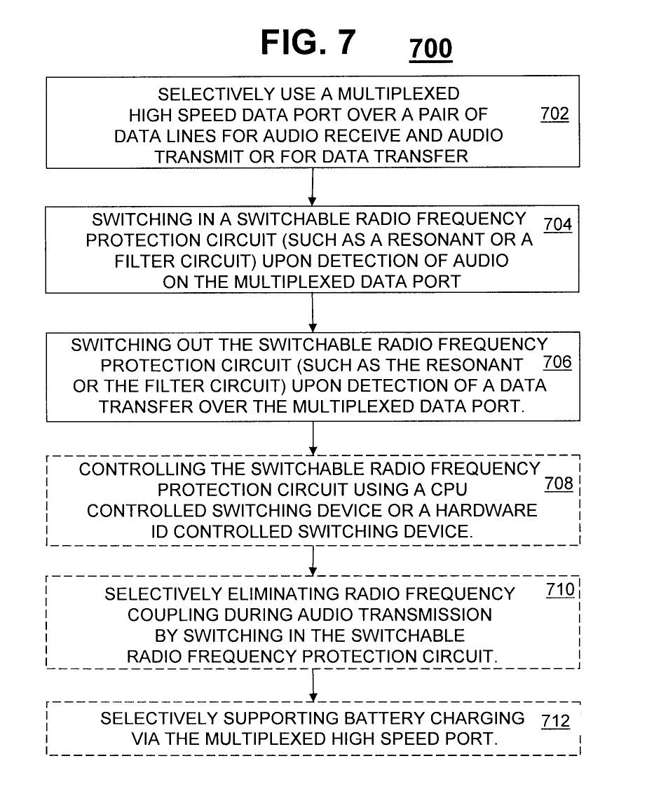

Referring to FIG. 7, a method 700 of eliminating radio frequency coupling to a multiplexed high speed port supporting data transfer and audio transmission can include the step 702 of selectively using the multiplexed high speed data port over a pair of data lines for audio receive and audio transmit or for data transfer, switching in a switchable radio frequency protection circuit (such as a resonant circuit or a filter circuit) upon detection of an audio transmission on the multiplexed high speed data port at step 704, and switching out the switchable radio frequency protection circuit upon detection of a data transfer over the multiplexed high speed data port at step 706. The method 700 can further include the step 708 of controlling the switchable radio frequency protection circuit using a computer processing unit controlled switching device or a hardware identifier controlled switching device or both. The method 700 can selectively eliminate radio frequency coupling during audio transmission by switching in the switchable radio frequency protection circuit at step 710. Note, the method can also selectively support battery charging at step 712 via the multiplexed high speed port.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A communication device, comprising:
a external data port for at least data transfer and audio transmission; and
a switchable radio frequency protection circuit that switches in a resonant circuit or filter circuit upon detection of an audio transmission and switches out the resonant circuit or filter circuit upon detection of data transfer over the external data port.

2. The communication device of claim 1, wherein the switchable protection circuit comprises a computer processing unit controlled switching device.

3. The communication device of claim 1, wherein the switchable protection circuit comprises a hardware identifier controlled switching device.

4. The communication device of claim 1 wherein the switchable protection circuit comprises a computer processing unit controlled switching device or a hardware identifier controlled switching device.

5. The communication device of claim 1, wherein the communication device further comprises data + and data − lines for audio receive and audio transmit.

6. The communication device of claim 1, wherein the communication device is a cellular phone having a high speed USB data port used for both data transfer and audio transmission, wherein the switchable radio frequency protection circuit selectively eliminates radio frequency coupling.

7. The communication device of claim 1, wherein the communication device is a GSM cellular phone and the external data port includes a USB connector having a data + line and a data − line used for both data transfer and audio transmission.

8. The communication device of claim 1, wherein the communication device is a laptop computer.

9. The communication device of claim 1, wherein the external data port is a multiplexed port supporting at least data transfer and audio.

10. A circuit for eliminating radio frequency coupling to a multiplexed high speed port supporting data transfer and audio transmission, comprising:
a pair of data lines used for audio receive and audio transmit via the multiplexed high speed port; and
a switchable radio frequency protection circuit that switches in a resonant circuit or a filter circuit upon detection of an audio transmission and switches out the resonant circuit or filter circuit upon detection of a data transfer over the external data port.

11. The circuit of claim 10, wherein the switchable protection circuit comprises a computer processing unit controlled switching device or a hardware identifier controlled switching device.

12. The circuit of claim 10, wherein the circuit is a portion of a cellular phone having a high speed USB data port used for both data transfer and audio transmission, wherein the switchable radio frequency protection circuit selectively eliminates radio frequency coupling during audio transmission.

13. The circuit of claim 10, wherein the circuit is a portion of a GSM cellular phone and the multiplexed high speed port includes a USB connector having a data + line and a data − line used for both data transfer and audio transmission.

14. The circuit of claim 10, wherein the multiplexed high speed port is a multiplexed port supporting at least data transfer, audio transmission, and battery charging.

15. A method of eliminating radio frequency coupling to a multiplexed high speed port supporting data transfer and audio transmission, comprising the steps of:
selectively using the multiplexed high speed data port over a pair of data lines for audio receive and audio transmit or for data transfer;
switching in a switchable radio frequency protection circuit upon detection of an audio transmission on the multiplexed high speed data port; and
switching out the switchable radio frequency protection circuit upon detection of a data transfer over the multiplexed high speed data port.

16. The method of claim 15, wherein the step of switching in comprises the step of switching in a resonant circuit or a filter circuit upon detection of the audio transmission.

17. The method of claim 15, wherein the step of switching out comprises the step of switching out a resonant circuit or a filter circuit upon detection of the data transfer over the multiplexed high speed data port.

18. The method of claim 15, wherein the method further comprises the step of controlling the switchable radio frequency protection circuit using a computer processing unit controlled switching device or a hardware identifier controlled switching device.

19. The method of claim 15, wherein the method selectively eliminates radio frequency coupling during audio transmission by switching in the switchable radio frequency protection circuit.

20. The method of claim 15, wherein the method further selectively supports battery charging via the multiplexed high speed port.
